(19) United States
(12) Patent Application Publication
(10) Pub. No.: US 2026/0230466 A1
(43) Pub. Date: Aug. 6, 2026

(54) COMPOSITE MODEL FRAMEWORK FOR AUTHORIZATION REQUEST AUGMENTATION

(71) Applicant: OPTUM, INC., Minnetonka, MN (US)

(72) Inventors: Vishwakant GUPTA, Jaipur (IN); Gaurav MANTRI, Rajasthan (IN); Shubhangi -, Noida (IN); Jahanvi TALWAR, Indore (IN)

(21) Appl. No.: 19/037,517

(22) Filed: Jan. 27, 2025

(51) Int. Cl. H04L 9/40; G06F 18/241; G06N 20/00

(52) U.S. Cl. CPC H04L 63/083; G06F 18/241; G06N 20/00

(57) ABSTRACT

Various embodiments of the present disclosure provide an authorization request augmentation process that improves the functionality of a computer in various aspects. The techniques comprise receiving an authorization request, generating a candidate code from among a set of defined codes, storing, a set of data objects associated with the authorization request, generating, a tagged data object by associating a token of the data object with a tagged code from the set of defined codes, and based at least in part on determining that the candidate code matches the tagged code, providing an augmented authorization request to an entity repository.

### BACKGROUND

In various domains, messages are passed between systems using messaging interfaces that connect the systems via a communication channel. Messages may be passed for various use cases comprising decision processing and information sharing to name a few. In each case, the messaging interfaces used are traditionally agnostic to the reasoning for the message and instead focus on the singular task of transferring a message between two systems. This results in the instantiation of multiple messaging interfaces in which messages must be transferred between entities and then processed using data from data sources separately located from either entity. To address challenges presented by multiple interfaces, universal interfaces may be implemented that define pathways between a set of different network locations to reduce the number of interface permutations necessary for a given task. However, traditional universal interfaces still require multiple request, response, and retrieval messages to perform complex decisions. For example, in a decisioning system, a message may be initially passed to request an authorization of a particular activity that is governed by a ruleset stored in one data source based on authorization information stored in another data source. Traditional message interfaces, even if universally connected to each of the required data sources, require multiple message passing operations to retrieve the necessary contextual information (e.g., the authorization ruleset, the authorization information) required to process the message, which reduces the speed, efficiency, and productivity of downstream computing systems.

### BRIEF DESCRIPTION OF THE DRAWINGS

FIG. 1 depicts a block diagram of an example architecture in accordance with some embodiments of the present disclosure.

FIG. 2 depicts a block diagram of an example predictive data analysis computing entity in accordance with some embodiments of the present disclosure.

FIG. 3 depicts a block diagram of an example client computing entity in accordance with some embodiments of the present disclosure.

FIG. 4 depicts a dataflow diagram of a composite model framework in accordance with some embodiments of the present disclosure.

FIG. 5 depicts an operational example of an approach for generating a set of classification predictions in accordance with some embodiments of the present disclosure.

FIG. 6 depicts a flowchart diagram of authorization request augmentation process in accordance with some embodiments of the present disclosure.

### DETAILED DESCRIPTION

Embodiments of the present disclosure provide machine learning frameworks and architectures that improve the functionality of a computer with respect to various computing tasks, including messaging interfaces and network-based decisioning systems. To do so, some embodiments of the present disclosure provide intermediary messaging interfaces that leverage a composite model framework to automatically intercept and augment authorization requests and/or authorization responses as they pass between decision points within a decisioning system. For example, the composite model framework may apply a specific arrangement of classification machine learning models to preemptively detect, retrieve, temporarily store, and/or augment a message with contextual information tailored to a downstream decisioning task. The intermediary messaging interface may then forward the augmented message, in place of the original, to a downstream decision system. By doing so, the intermediary messaging interface of the present disclosure may predictively augment a message within an intermediary environment, where access to connected data sources is faster, to reduce downstream information requests that traditionally reduce the speed and efficiency (e.g., in terms of processing and time allocations) of downstream decisioning systems.

Moreover, to overcome performance deficiencies with traditional data augmentation approaches, such as those that use standalone machine learning models, the composite model framework may define a multi-stage process in which predicted values are generated for authorization requests, data objects are stored in a temporary memory, tokens of the data objects are matched to the predicted values, and then a corresponding augmented authorization request is stored in an accessible repository accessible to a downstream decisioning system. To improve the prediction speed of the composite model framework (e.g., in order to allow its application within an intermediary messaging interface), the composite model framework may divide the prediction process into individual units that may be resolved using a sequence of connected machine learning models. For example, the sequence of connected machine learning models may comprise a unique arrangement of multi-label classification models, token-level classification models, and/or computing services, such as filtering services and data repositories, that may be implemented in a vast number of different model architectures each designed, in terms accuracy, speed, and efficiency, with respect to different units of the prediction process. For example, the composite model framework may connect a multi-label classification model and/or token-level classification model into a single predictive unit to generate predictive values, such as candidate codes within a message. At the same time, composite model framework may implement computing services to extract, retrieve, and/or store data to facilitate the predictions of the classification machine learning models and/or integrate the connected model framework with upstream and/or downstream computing components. As a result, the techniques of the present disclosure enable implementation of a predictive authorization request augmentation platform for implementing an authorization request augmentation platform, using less computing resources and achieving a higher degree of processing speed.

Examples of technologically advantageous embodiments of the present disclosure comprise improved distribution of functionality, such as classification machine learning models and/or computing services, within a composite model framework to intercept authorization requests, generate augmented authorization requests, and store the augmented authorization requests, among other aspects of the present disclosure. In doing so, the composite model framework of the present disclosure may improve the speed and efficiency of messaging interfaces and automated decisioning systems associated therewith. Other technical improvements and advantages may be realized by one of ordinary skill in the art.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

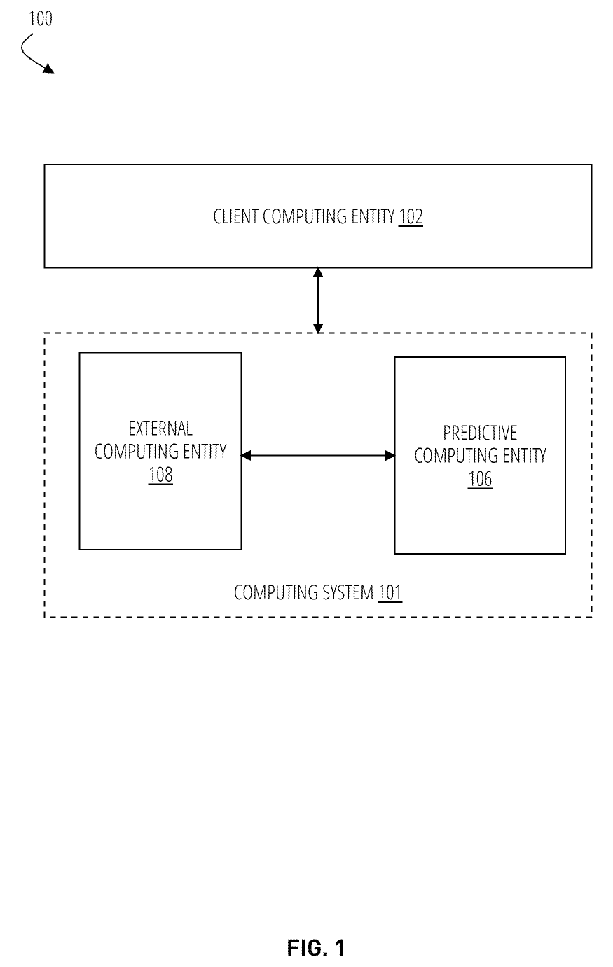

FIG. 1 depicts a block diagram of an example architecture 100 in accordance with some embodiments of the present disclosure. The architecture 100 comprises a computing system 101 configured to receive an authorization request from client computing entities 102, process the authorization request, and provide an augmented authorization request to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models may be trained to generate candidate outputs, candidate output scores, and/or other machine learned outputs. The models may be adapted to composite model framework that collectively processes an authorization request using a modular model and services ensemble.

In some embodiments, the computing system 101 may communicate with at least one of the client computing entities 102 using one or more communication networks. Examples of communication networks comprise any wired or wireless communication network comprising, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code prediction, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more authorization request augmentation techniques described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as data objects, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operation of the present disclosure. In some examples, feedback (e.g., evaluation data and ground truth data) from the use of the machine learning model may be received and/or stored by the predictive computing entity 106. In some examples, the feedback may be provided to the one or more external computing entities 108 to continuously train the machine learning model over time. In some examples, the feedback may be leverages by the predictive computing entity 106 to continuously train the machine learning model over time. In this manner, the computing system 101 may perform, via one or more combination of computing entities, one or more prediction, training, ask/or any other machine learning-based techniques of the present disclosure.

### A. Example Computing Entity

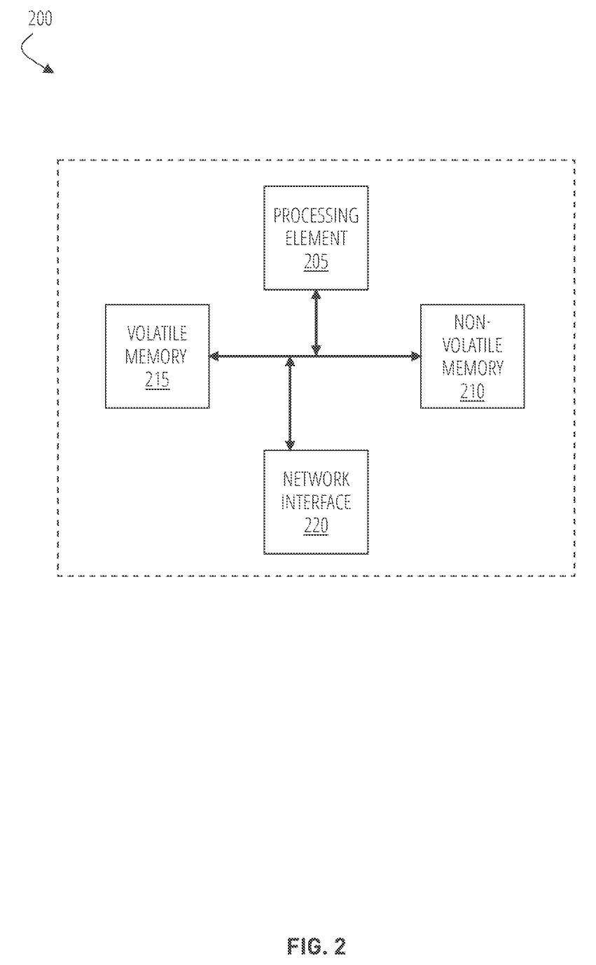

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably), volatile memory 215 (also referred to as volatile media, storage, memory storage, memory circuitry, and/or similar terms used herein interchangeably), quantum memory (e.g., solid quantum memory, atomic gas quantum memory), and/or the like.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium comprising random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (comprising various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilize quantum bits, or qubits, which may exist in multiple states simultaneously through a property called superposition. Unlike classical bits that may only be in a state of 0 or 1, qubits may represent both states at once, allowing for exponentially larger information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, comprising as computer program products that comprise articles of manufacture. Such computer program products may comprise one or more software components comprising, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (comprising volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

In some embodiments, one or more embodiments of the present disclosure may be implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computer entity 200 may be specialized for machine learning task. By way of example, large language models (LLMs) and other transformer networks may be specially designed for operation within a quantum environment by replacing weight matrices in self-attention and/or multi-layer perceptron layers of such models with one or more combinations of two variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures of the present disclosure may be configured for classical computer or quantum computers based on the embodiment.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communications with one or more input elements/devices, such as input sensor(s). In some examples, the input sensor(s) may comprise one or more keyboards, pointing devices (e.g., mouse, trackpad), touch screens, cameras, (e.g., infrared light camera, visual light camera), depth sensors (e.g., LIDAR, radar, stereo cameras), gyroscopes, location sensors (e.g., global positioning system (GPS), Hall effect sensor, laser, doppler vibrometer), microphones, and/or the like. The computing entity 200 may additionally or alternatively comprise, or be in communication with one or more output elements/devices (not shown) such as one or more speakers, visual display devices, haptic feedback devices, motion devices (e.g., electromechanically actuated devices), and/or the like.

### B. Example Client Computing Entity

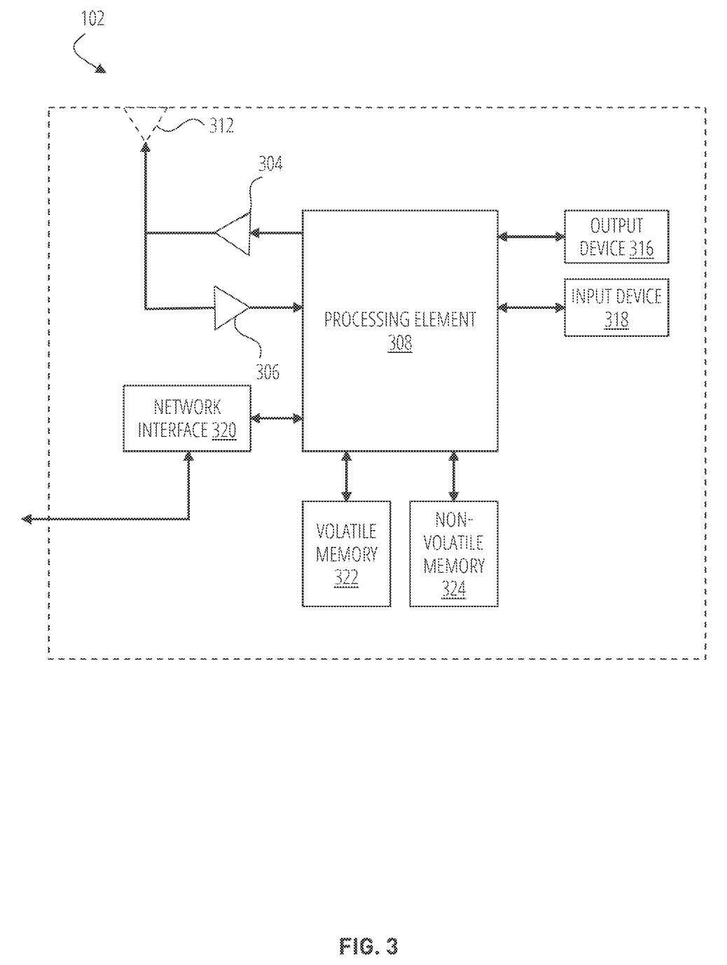

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., comprising executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, comprising Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, comprising cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies comprising RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Example System Operations

As indicated, various embodiments of the present disclosure make important technical contributions to machine learning and computing services frameworks. In particular, systems and methods are disclosed herein that implement an authorization request augmentation process. By doing so, the authorization request augmentation techniques of the present disclosure enable improved predictions while reducing computing resource consumption. This, in turn, may improve the functionality of a computer with respect to various computing tasks, comprising increased functionality, machine learning, integration with downstream models, and/or the like.

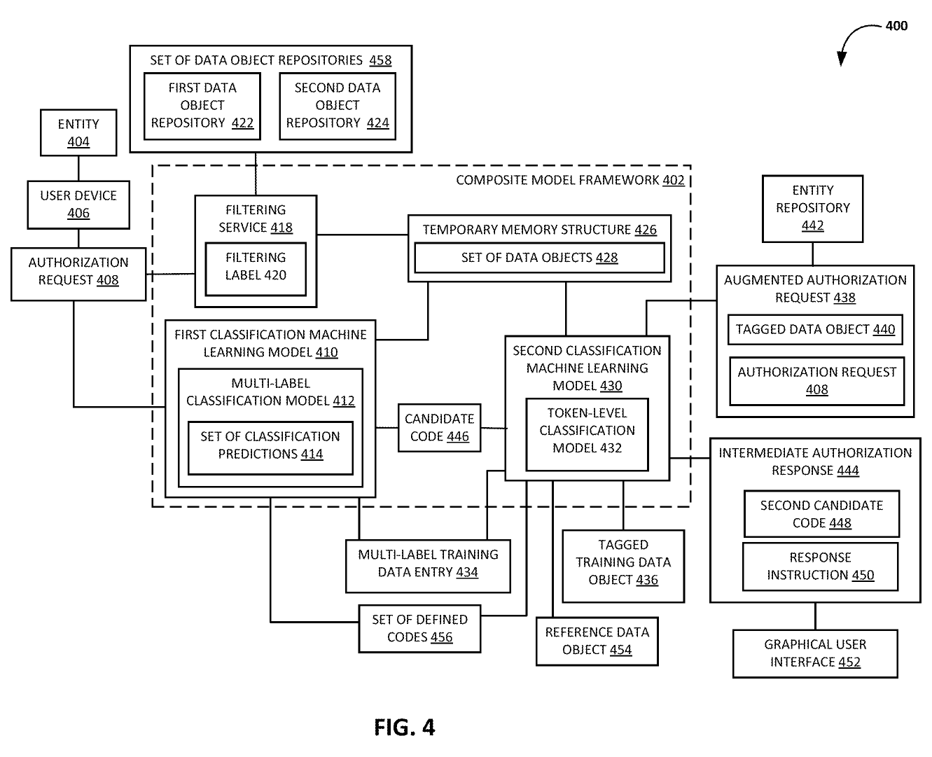

FIG. 4 depicts a dataflow diagram 400 of a composite model framework in accordance with some embodiments of the present disclosure. The dataflow diagram 400, for example illustrates a composite model framework 402 for generating a candidate code 446, storing a set of data objects 428, generating a tagged data object 440, and providing an augmented authorization request 438. For example, the composite model framework 402 may comprise a filtering service 418, a temporary memory structure 426, a first classification machine learning model 410, a second classification machine learning model 430, and/or the like associated with the authorization request augmentation process.

In some embodiments, the computing system 101 receives an authorization request 408 for an entity 404. In some embodiments, the authorization request 408 is received from a user device 406. In some embodiments, the user device 406 is associated with the entity 404.

In some embodiments, the entity 404 may comprise an individual or a collection of individuals associated with the authorization request 408. By way of example, the entity 404 may be a provider or collection of providers that provide services to users. In this regard, in some embodiments, the user device 406 is associated with an individual or a collection of individuals associated with an authorization request. In some embodiments, a user is an individual that receives services from the entity 404. Additionally, or alternatively, the entity 404 may be an automated agent associated with the authorization request 408. In this regard, in some embodiments, the user device 406 is a computing device that operates, executes, and/or implements the automated agent. By way of example, the entity 404 may be an automated agent that generates the authorization request 408 by extracting labels associated with an authorization request from one or more data sources. As another example, the entity 404 may be an automated agent that provides the authorization request 408 to an enterprise associated with the composite model framework 402. In some embodiments, an enterprise may comprise a provider and/or operator of the composite model framework 402.

In some embodiments, the authorization request 408 may comprise a data structure that is indicative of operations of the entity 404. In this regard, for example, the authorization request 408 may be indicative of a claim related to services provided by the entity 404 to a user. In some embodiments, the authorization request 408 comprises one or more labels associated with the authorization request 408. In some embodiments, the authorization request 408 may be indicative of a request to approve operations of the entity 404. For example, the authorization request 408 may be indicative of a request to approve a claim related to services provided by the entity 404 to a user.

In some embodiments, a label may comprise one or more items of data indicative of an attribute associated with the authorization request 408. In this regard, in some embodiments, a label may comprise a user identifier that uniquely identifies a user associated with the authorization request 408. Additionally, or alternatively, a label may comprise an entity identifier that uniquely identifies the entity 404 associated with the authorization request 408. Additionally, or alternatively, a label may comprise a diagnosis code associated with the authorization request 408. Additionally, or alternatively, a label may comprise a procedure code associated with the authorization request 408. Additionally, or alternatively, a label may comprise a policy identifier that uniquely identifies a policy associated with a user and/or the entity 404 associated with the authorization request 408. Additionally, or alternatively, a label may comprise a temporal indicator that associated with the authorization request 408 that is indicative of a date upon which the entity 404 and/or an individual associated with the entity 404 provided services to a user that correspond to the authorization request 408. Additionally, or alternatively, a label may comprise a historical indicator indicative of one or more other authorization requests related to the authorization request 408. Additionally, or alternatively, a label may be indicative of one or more of a set of defined codes 456 associated with the authorization request 408.

In some embodiments, the computing system 101, using a filtering service 418 of the composite model framework 402, extracts a filtering label 420 from the authorization request 408. In some embodiments, the filtering label 420 is a label that is extracted from the authorization request 408 and/or used to perform one or more retrieval, storage, and/or filtering operations. In this regard, in some embodiments, the filtering label 420 is a user identifier, an entity identifier, a diagnosis code, a procedure code, a policy, a temporal indicator, and/or a historical indicator associated with the authorization request 408 that is used to perform one or more retrieval, storage, and/or filtering operations.

In some embodiments, the computing system 101, by the filtering service 418 of the composite model framework 402, retrieves a set of data objects 428. In some embodiments, the set of data objects 428 is retrieved from one or more of a set of data object repositories 458. For example, a data object of the set of data objects 428 may be retrieved from a first data object repository 422 of the set of data object repositories 458. As another example, a second data object of the set of data objects 428 may be retrieved from a second data object repository 424 of the set of data object repositories 458.

In some embodiments, a data object repository of the set of data object repositories 458 comprises a database stored on a memory device, which is accessible by one or more computing devices for retrieval and storage of data associated with the composite model framework 402. A data object repository of the set of data object repositories 458 may be dynamically updated or be static. In some embodiments, a data object repository of the set of data object repositories 458 is encrypted in order to limit unauthorized access of the set of data objects 428 and/or other data associated with the composite model framework 402. In some embodiments, a data object repository of the set of data object repositories 458 is a component of the composite model framework 402. For example, the first data object repository 422 may be a component of the composite model framework 402. Additionally, or alternatively, a data object repository of the set of data object repositories 458 is not a component of the composite model framework 402 (e.g., is externally located and/or remotely located). For example, the second data object repository 424 may not be a component of the composite model framework 402.

In some embodiments, for example, a data object repository of the set of data object repositories 458 may be associated with an authorization response management platform. As another example, a data object repository of the set of data object repositories 458 may be associated with an external management record system (e.g., an external management record system associated with the entity 404). As another example, a data object repository of the set of data object repositories 458 may be associated with a user health record system. As another example, a data object repository of the set of data object repositories 458 may be associated with a laboratory. As another example, a data object repository of the set of data object repositories 458 may be associated with a radiography system.

In some embodiments, a data object of the set of data objects 428 comprises an image, text-based document, tabular structure, and/or the like corresponding to the authorization request 408. For example, a data object may comprise an image, text-based document, tabular structure, and/or the like that is indicative of a medical record (e.g., a text-based medical record), a radiology result (e.g., an image-based radiology result), a digital imaging and communications in medicine (DICOM) file, and/or a health level 7 (HL7) lab result.

In some embodiments, the computing system 101 stores the set of data objects 428 within a temporary memory structure 426. In some embodiments, the computing system 101 stores the set of data objects 428 within the temporary memory structure 426 in response to generation of a candidate code 446.

In some embodiments, the temporary memory structure 426 comprises a database stored on a memory device, which is accessible by one or more computing devices for temporary storage of the set of data objects 428 and/or other data associated with the composite model framework 402 In some embodiments, the temporary memory structure 426 is encrypted in order to limit unauthorized access of the set of data objects 428 and/or other data associated with the composite model framework 402. In some embodiments, the temporary memory structure 426 is configured to store one or more of the set of data objects 428 until an augmented authorization request 438 has been generated. Additionally, or alternatively, the temporary memory structure 426 may be configured to remove one or more of the set of data objects 428 based at least in part on determining that the candidate code 446 does not match a second tagged code from the set of defined codes 456. In some embodiments, the temporary memory structure 426 is a component of the composite model framework 402. In some embodiments, the temporary memory structure 426 is not a component of the composite model framework 402 (e.g., is externally located and/or remotely located).

In some embodiments, the computing system 101, by the filtering service 418 of the composite model framework 402, a token from a tabular structure. In some embodiments, responsive to extracting the token from the tabular structure, the computing system 101 generates a data object of the set of data objects 428. In some embodiments, a data object generated responsive to extracting a token from a tabular structure may comprise an image and/or a text-based document (e.g., a PDF). In this regard, in some embodiments, the filtering service 418 is configured to extract tokens from tabular structures and convert the tokens generating image and/or a text-based document (e.g., a PDF) comprising the token.

In some embodiments, the filtering service 418 is hardware and/or software comprising parameters, hyper-parameters, and/or defined operations of a rules-based and/or machine learning model (e.g., model comprising at least one of one or more rule-based layers, one or more layers that depend on trained parameters, coefficients, and/or the like). In some embodiments, the filtering service 418 is configured, trained, and/or the like to perform one or more retrieval, extraction, storage, and/or filtering operations. For example, the filtering service 418 may be configured, trained, and/or the like to extract the filtering label 420 from the authorization request 408. As another example, the filtering service 418 may be configured, trained, and/or the like to retrieve the set of data objects 428 from the set of data object repositories 458. In this regard, for example, the filtering service 418 may be configured, trained, and/or the like to filter the set of data objects 428 to extract documents relevant to the authorization request 408. As another example, the filtering service 418 may be configured, trained, and/or the like to store the set of data objects 429 within the temporary memory structure 426. In some embodiments, filtering service 418 is a component of the composite model framework 402. In some embodiments, the filtering service 418 is not a component of the composite model framework 402 (e.g., is externally located and/or remotely located).

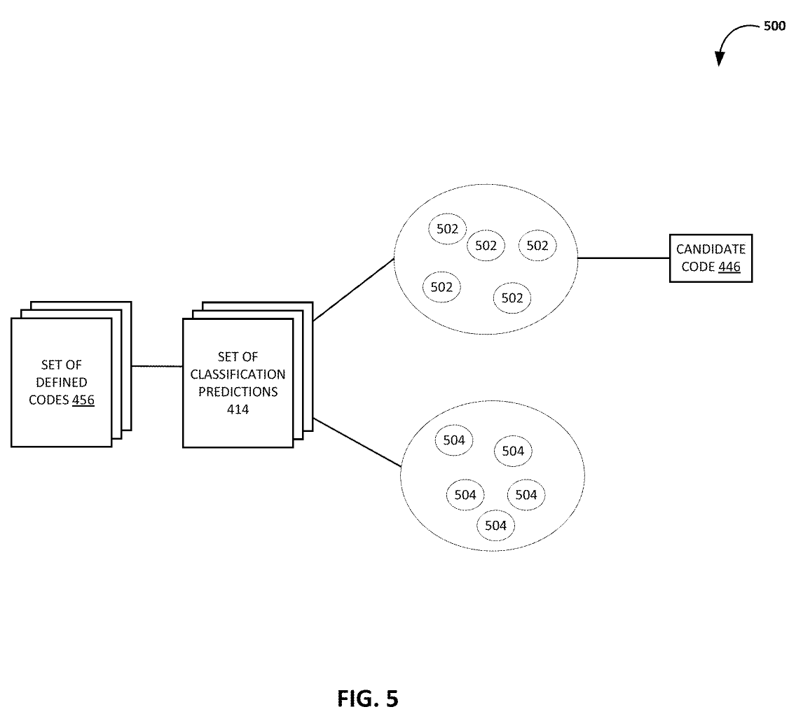

In some embodiments, the computing system 101, using a first classification machine learning model 410 of the composite model framework 402 and based at least in part on the authorization request 408, generates a candidate code 446 from among the set of defined codes 456. In some embodiments, the first classification machine learning model 410 comprises a multi-label classification model 412 that is configured to generate a set of classification predictions that respectively correspond to the set of defined codes 456. In some embodiments, as described in further detail with reference to FIG. 5, the candidate code corresponds to a classification prediction of the set of classification predictions that meets or exceeds a classification threshold.

In some embodiments, the set of defined codes 456 comprises one or more defined codes. In some embodiments, a defined code comprises a data structure indicative of a type of content. In this regard, in some embodiments, a defined code may comprise a data structure indicative of a consent form (CK), a lab result (LR), a justification for admission (15), a medical record attachment (M1), a supporting claim attachment (OZ), a certification (CT), an explanation of benefits (EB), and/or operative notes (OB). In some embodiments, a consent form (CK) is a consent form corresponding to the authorization request 408. In some embodiments, a lab result (LR), is a result of a medical lab corresponding to the authorization request 408. In some embodiments, a justification for admission (15) corresponding to the authorization request 407 that provides a justification for admitting a user to a medical environment (e.g., a hospital) corresponding to the authorization request 408. In some embodiments, medical record attachment (M1) corresponding to the authorization request 408 that provides a medical record of a user. In some embodiments, an explanation of benefits (EB) is an explanation of benefits corresponding to the authorization request that provides an explanation of benefits available to a user. In some embodiments, operative notes (OB) are notes corresponding to the authorization request 408 that relate to one or more services provided to a user.

In some embodiments, the candidate code 446 may comprise one or more data structures indicative of a type of content that corresponds to the authorization request 408. For example, the candidate code 446 may comprise a data structure indicative of a type of content that corresponds to the authorization request 408 and is used to provide the augmented authorization request 438. In this regard, in some embodiments, the candidate code 446 may comprise a data structure indicative of a consent form (CK), a lab result (LR), a justification for admission (15), a medical record attachment (M1), a supporting claim attachment (OZ), a certification (CT), an explanation of benefits (EB), and/or operative notes (OB) corresponding to the authorization request 408. In some embodiments, the candidate code 446 corresponds to one of the set of defined codes 456. Said differently, for example, a type of content that corresponds to the authorization request 408 may correspond to a type of content represented by one of the set of defined codes 456.

In some embodiments, the first classification machine learning model 410 is hardware and/or software comprising parameters, hyper-parameters, and/or defined operations of one or more rules-based and/or machine learning models (e.g., models comprising at least one of one or more rule-based layers, one or more layers that depend on trained parameters, coefficients, and/or the like) configured to generate the candidate code 446. In some embodiments, the first classification machine learning model 410 comprises multi-label classification model 412. In this regard, for example, the first classification machine learning model 410 may comprise a decision tree-based classification model.

In some embodiments, the set of classification predictions 414 comprises one or more classification predictions. In some embodiments, a classification prediction is a value indicative of whether a defined code is represented in the authorization request. For example, a classification prediction may be a probabilistic value, such as a logit probability, indicative of whether a defined code is represented in the authorization request. In some embodiments, a classification threshold is a threshold for determining whether a classification prediction corresponds to the candidate code 446. In this regard, in some embodiments, if a classification prediction meets or exceeds the classification threshold, the classification prediction corresponds to the candidate code 446. For example, if a classification prediction corresponds to a defined code indicative of a consent form (CK) and meets or exceeds the classification threshold, then the candidate code 445 is indicative of a consent form (CK). In some embodiments, if a classification prediction does not meet or exceed the classification threshold, the classification prediction does not correspond to the candidate code 446. For example, if a classification prediction corresponds to a defined code indicative of a consent form (CK) and does not meet or exceed the classification threshold, then the candidate code 445 is not indicative of a consent form (CK). In this regard, in some embodiments, the first classification machine learning model 410 may output n classification predictions (where n is a positive integer) that respectively represent a score (e.g., a logit indicating a posterior probability that a defined code from among the set of defined codes 456 is relevant) indicative of whether a defined code is represented in the authorization request 408. In some embodiments, the n classification predictions may correspond to the number of codes in the set of defined codes 456. In some embodiments, the n classification predictions may be ranked based on respective scores.

In some embodiments, the computing system 101, using a second classification machine learning model 430 of the composite model framework 402 and based at least in part on a data object of the set of data objects 428, generates a tagged data object 440 by associating a token of the data object with a tagged code from the set of defined codes 456. In some embodiments, a data object of the set of data objects 428 comprises a set of tokens.

In some embodiments, the set of tokens comprises one or more tokens. In some embodiments, a token comprises a data structure indicative of content within a data object of the set of data objects 428. In this regard, in some embodiments, a token may comprise a data structure indicative of content within an image, a text-based document, a tabular structure, and/or the like. For example, a token may comprise a data structure indicative of content withing a medical record (e.g., a text-based medical record), a radiology result (e.g., an image-based radiology result), a digital imaging and communications in medicine (DICOM) file, a health level 7 (HL7) lab result, and/or the like. A data structure, for example, may comprise a real number, an array, a unique identifier, text, images, and/or the like.

In some embodiments, the tagged code may comprise a data structure indicative of a type of content that corresponds to a data object of the set of data objects 428. For example, the tagged code may comprise a data structure indicative of a type of content that corresponds to a data object of the set of data objects 428 and/or used to provide the augmented authorization request 438. For example, the tagged code may indicate a consent form (CK), a lab result (LR), a justification for admission (15), a medical record attachment (M1), a supporting claim attachment (OZ), a certification (CT), an explanation of benefits (EB), operative notes (OB), and/or any other one or more of the set of defined codes 456. In some embodiments, the tagged code is one of the sets of defined codes 456. Said differently, for example, a type of content that corresponds to a data object of the set of data objects 428 may correspond to a type of content represented by one of the sets of defined codes 456.

In some embodiments, generating the tagged data object 440 from the data object of the set of data objects 428 comprises generating, by the second classification machine learning model 430, a set of code predictions that respectively correspond to the set of tokens. In some embodiments, generating the tagged data object 440 from the data object of the set of data objects 428 comprises assigning based on the set of code predictions, one or more tagged codes to the data object or portion(s) thereof corresponding to particular token(s) of a set of tokens generated for the data object.

In some embodiments, the set of code predictions comprises one or more code predictions. In some embodiments, a code prediction is a value indicative of whether a token in a data object of the set of data objects 428 corresponds to a tagged code of the set of defined codes 456. For example, a code prediction may be a score (e.g., a probabilistic value) indicative of whether a token in a data object of the set of data objects 428 corresponds to a tagged code of the set of defined codes 456. In some embodiments, a code threshold is a threshold for determining whether a token in a data object of the set of data objects 428 corresponds to a tagged code of the set of defined codes 456. In this regard, in some embodiments, if a code prediction meets or exceeds the code threshold, the token in a data object of the set of data objects 428 corresponds to a tagged code of the set of defined codes 456. In some embodiments, if a code prediction meets or exceeds the code threshold, the tagged code may be assigned to the data object. In some embodiments, if a code prediction does not meet or exceed the code threshold, the token in a data object of the set of data objects 428 does not correspond to a tagged code of the set of defined codes 456. In some embodiments, if a code prediction does not meet or exceed the code threshold, the tagged code may not be assigned to the data object.

In some embodiments, the second classification machine learning model 430 is hardware and/or software comprising parameters, hyper-parameters, and/or defined operations of one or more rules-based and/or machine learning models (e.g., models comprising at least one of one or more rule-based layers, one or more layers that depend on trained parameters, coefficients, and/or the like) configured to generate a tagged data object 440. In some embodiments, the second classification machine learning model 430 comprises a token-level classification model 432. In some embodiments, the first classification machine learning model 410 and the second classification machine learning model 430 may be one machine-learned model or different machine-learned models.

In some embodiments, a tagged data object 440 comprises an image, text-based document, tabular structure, and/or the like corresponding to the authorization request 408 and one or more tagged codes indicative of a type of content of the image, text-based document, tabular structure, and/or the like. Said differently, for example, a tagged data object 440 comprises a data object of the set of data objects 428 and one or more tagged codes that correspond to the data object. For example, a tagged data object 440 may comprise a data structure indicative of a medical record (e.g., a text-based medical record) and a data structure indicative of a medical record attachment (M1). As another example, a tagged data object 440 may comprise a data structure indicative of a health level 7 (HL7) lab result and a data structure indicative of a consent form (CK).

In some embodiments, based at least in part on determining that the candidate code 446 matches a tagged code, the computing system 101 provides the augmented authorization request 438 to an entity repository 442. For example, the candidate code 446 may match a tagged code if the candidate code 446 comprises a data structure indicative of a consent form (CK) corresponding to the authorization request 408 and the tagged code comprises data structure indicative of a consent form (CK) corresponding to a data object of the set of data objects 428. In some embodiments, based at least in part on determining that the candidate code 446 does not match a tagged code, removing a data object of the set of data objects 428 from the temporary memory structure 426.

In some embodiments, the augmented authorization request 438 comprises the authorization request 408 and the tagged data object 440. In this regard, for example, the augmented authorization request 438 may comprise a data structure that is indicative of operations of the entity 404, an image, text-based document, tabular structure, and/or the like corresponding to the authorization request 408, one or more tagged codes indicative of a type of content of the image, text-based document, tabular structure, and/or the like. In some embodiments, the augmented authorization request 438 may be indicative of a request to approve operations of the entity 404. For example, the augmented authorization request 438 may be indicative of a request to approve a claim related to services provided by the entity 404 to the user.

In some embodiments, the entity repository 442 comprises a database stored on a memory device, which is accessible by one or more computing devices for retrieval and storage of data associated with the composite model framework 402. The entity repository 442 may be dynamically updated or be static. In some embodiments, the entity repository 442 is encrypted in order to limit unauthorized access of the augmented authorization request 438 and/or other data associated with the composite model framework 402. In some embodiments, the entity repository 442 is a component of the composite model framework 402. Additionally, or alternatively, the entity repository 442 of is not a component of the composite model framework 402 (e.g., is externally located and/or remotely located).

In some embodiments, the computing system 101, by the second classification machine learning model 430 of the composite model framework 402 and based at least in part on a second data object of the set of data objects 428, generates a second tagged data object by associating a second token of the data object of the set of data objects 428 with a second tagged code from the set of defined codes. In some embodiments, based at least in part in part on determining that the candidate code 446 does not match the second tagged code, the computing system 101 removes the second data object from the temporary memory structure 426. For example, the candidate code 446 may not match a second tagged code if the candidate code 446 comprises a data structure indicative of a consent form (CK) corresponding to the authorization request 408 and the second tagged code comprises a data structure indicative of a medical record attachment (M1) corresponding to a second data object of the set of data objects 428. In some embodiments, multiple candidate codes may be compared against multiple tagged codes (e.g., a set of candidate codes may be compared against a set of tagged codes). In some embodiments, computing system 101 may remove the second data object from the temporary memory structure 426 by transmitting a command to the temporary memory structure 426 to remove or delete the second data object.

In some embodiments, the computing system 101, by the first classification machine learning model 410 of the composite model framework 402 and based at least in part on the authorization request 408, generates a second candidate code 448. In some embodiments, based at least in part on determining that the second candidate code 448 does not match the tagged code, the computing system 101, provides, to the user device 406, an intermediate authorization response 444.

In some embodiments, the intermediate authorization response 444 comprises the second candidate code 448. In some embodiments, the intermediate authorization response 444 comprises a response instruction 450. In some embodiments, the response instruction 450 comprises one or more items of data indicative of an instruction to the entity 404 to provide a data object corresponding to the second candidate code 448. In some embodiments, the computing system 101 outputs the response instruction 450 for rendering to a graphical user interface 452. In some embodiments, the graphical user interface 452 is provided on the user device 406.

In some embodiments, the computing system 101 trains the multi-label classification model 412. In some embodiments, the multi-label classification model 412 is trained using a multi-label training data entry 434. In some embodiments, the multi-label training data entry 434 comprises a historical authorization request. Additionally, or alternatively, the multi-label training data entry 434 comprises a ground truth code set. In some embodiments, the ground truth code set is automatically generated by applying a reference data object corresponding to the historical authorization request to the second classification machine learning model.

In some embodiments, the historical authorization request comprises a data structure that is indicative of historical operations of the entity 404 and/or one or more other entities. In this regard, for example, the historical authorization request may be indicative of one or more historical claims related to services provided by the entity 404 to a user and/or one or more historical claims related to services provided by one or more other entities to a user. In some embodiments, the historical authorization request may be indicative of a historical request to approve operations of the entity 404. For example, the historical authorization request may be indicative of a historical request to approve a claim related to services provided by the entity 404 to a user.

In some embodiments, a ground truth code set comprises one or more ground truth codes. In some embodiments, a ground truth code comprises a data structure indicative of a type of content that corresponds to the historical authorization request. For example, a ground truth code may comprise a data structure indicative of a type of content that corresponds to the historical authorization request and is used to provide the augmented authorization request 438. In this regard, in some embodiments, a ground truth code may comprise a data structure indicative of a consent form (CK), a lab result (LR), a justification for admission (15), a medical record attachment (M1), a supporting claim attachment (OZ), a certification (CT), an explanation of benefits (EB), and/or operative notes (OB) corresponding to the historical authorization request. In some embodiments, a ground truth code corresponds to one of the set of defined codes 456. Said differently, for example, a type of content that corresponds to the historical authorization request may correspond to a type of content represented by one of the set of defined codes 456.

In some embodiments, the reference data object 454 comprises an image, text-based document, tabular structure, and/or the like corresponding to the historical authorization request. For example, a data object may comprise an image, text-based document, tabular structure, and/or the like that is indicative of a medical record (e.g., a text-based medical record), a radiology result (e.g., an image-based radiology result), a digital imaging and communications in medicine (DICOM) file, and/or a health level 7 (HL7) lab result that corresponds to the historical authorization request. .

In some embodiments, the computing system 101 trains the token-level classification model 432 using a tagged training data object 436 that comprises a set of training tokens and a set of ground truth tags respectively corresponding to the set of training tokens. In some embodiments, the set of training tokens comprises one or more training tokens. In some embodiments, a training token comprises a data structure indicative of content within a historical data object. In this regard, in some embodiments, a training token may comprise a data structure indicative of content within a historical image, a text-based document, a tabular structure, and/or the like. For example, a training token may comprise a data structure indicative of content withing a historical medical record (e.g., a text-based medical record), a historical radiology result (e.g., an image-based radiology result), a historical digital imaging and communications in medicine (DICOM) file, a historical health level 7 (HL7) lab result, and/or the like. In some embodiments, the set of ground truth tags comprise one or more ground truth tags. In some embodiments, a ground truth tag is a value indicative of whether a training token in a historical data object corresponds to a tagged code of the set of defined codes 456.

In some embodiments, the computing system 101 determines, by a loss function, a loss associated with the second classification machine learning model 430. In some embodiments, the loss is determined based on a difference between a first ground truth tag of the set of ground truth tags and an output generated by the second classification machine learning model 430 based on a data object of the set of data objects 428. In some embodiments, the computing system 101 alters one or more parameters of the second classification machine learning model 430 using one or more of backpropagation, gradient descent, and/or the like to reduce the loss determined by the loss function.

FIG. 5 depicts an operational example 500 of an approach for generating the set of classification predictions 414 in accordance with some embodiments of the present disclosure. As depicted, and described herein, the approach comprises generating, by the first classification machine learning model 410, the set of classification predictions 414. The set of classification predictions 414 may respectively correspond to the set of defined codes 456. In some embodiments, the candidate code 446 respectively corresponds to a classification prediction of the set of classification predictions 414 that meets or exceeds a classification threshold. In this regard, in some embodiments, the first classification machine learning model 410 may output n classification predictions (where n is a positive integer) that respectively represent a score (e.g., a logit indicating a posterior probability that a defined code from among the set of defined codes 456 is relevant) indicative of whether a defined code is represented in the authorization request 408. In some embodiments, the n classification predictions may correspond to the number of codes in the set of defined codes 456. In some embodiments, the n classification predictions may be ranked based on respective scores. In some embodiments, n classification predictions that meet or exceed a classification threshold (e.g., n classification predictions associated with a score meeting or exceeding a threshold) may be sorted into a first subset of classification predictions 502 and/or n classification predictions that do not meet or exceed the classification threshold (e.g., n classification predictions associated with a score that does not meet or exceed a threshold) may be sorted into a second subset of classification predictions 504. In some embodiments, the candidate code 446 corresponds to a classification prediction from the first subset of classification predictions 502. For example, the candidate code 446 may correspond to a classification prediction from the first subset of classification predictions 502 associated with the highest score of the classification predictions in the first subset of classification predictions 502.

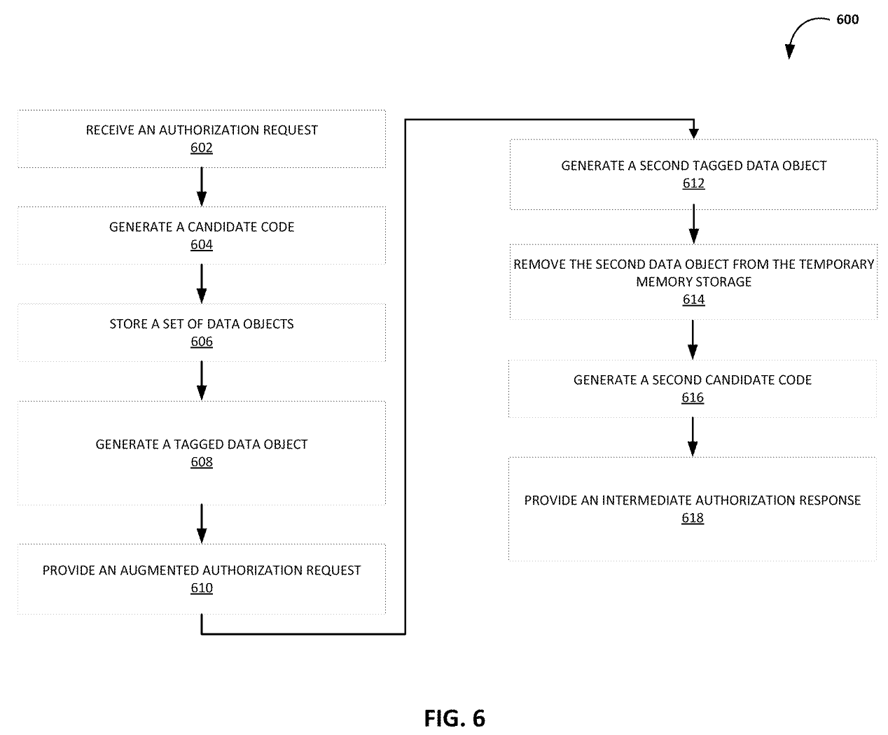

FIG. 6 is a flowchart diagram of an example authorization request augmentation process 600 in accordance with some embodiments of the present disclosure. The flowchart diagram depicts an authorization request augmentation process that is performed using a composite model framework that comprises a variety of machine learning models and/or computing services. The process 600 may be implemented by one or more computing devices, entities, and/or systems described herein. For example, via the various steps/operations of the process 600, the computing system 101 may automatically generate a candidate code, store a set of data objects 428, generate a tagged data object 440, and provide an augmented authorization request 438. By doing so, the authorization request augmentation techniques of the present disclosure enable improved predictions while reducing computing resource consumption. This, in turn, may improve the functionality of a computer with respect to various computing tasks, including increased functionality, machine learning, integration with downstream models, and/or the like.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 comprises, at step/operation 602, receiving an authorization request. For example, the computing system 101 may receive, by one or more processors, an authorization request for an entity.

In some embodiments, the process 600 comprises, at step/operation 604, generating a candidate code. For example, the computing system 101 may generate, by the one or more processors and using a first classification machine learning model of a composite model framework, a candidate code for the authorization request that corresponds to one of a set of defined codes. In some embodiments, the first classification machine learning model comprises a multi-label classification model that is configured to generate a set of classification predictions that respectively correspond to the set of defined codes and the candidate code corresponds to a classification prediction of the set of classification predictions that meets or exceeds a classification threshold. In some embodiments, the multi-label classification model is trained using a multi-label training data entry that comprises a historical authorization request and a ground truth code set. In some embodiments, the ground truth code set is automatically generated by applying a reference data object corresponding to the historical authorization request to the second classification machine learning model.

In some embodiments, the process 600 comprises, at step/operation 606, storing a set of data objects. For example, the computing system 101 may store, by the one or more processors and within a temporary memory structure, a set of data objects associated with the authorization request.

In some embodiments, storing, within the temporary memory structure, the set of data objects associated with the authorization request comprises extracting, using a filtering service of the composite model framework, a filtering label from the authorization request. In some embodiments, storing, within the temporary memory structure, the set of data objects associated with the authorization request comprises retrieving, by the filtering service of the composite model framework, the set of data objects. In some embodiments, the data object is retrieved from a first data object repository of a set of data object repositories and a second data object is retrieved from a second data object repository of the set of data object repositories.

In some embodiments, retrieving the set of data objects comprises extracting, by the filtering service of the composite model framework, the token from a tabular structure. In some embodiments, retrieving the set of data objects comprises responsive to extracting the token, generating the data object.

In some embodiments, the process 600 comprises, at step/operation 608, generating a tagged data object. For example, the computing system 101 may generate, by the one or more processors and using a second classification machine learning model of the composite model framework, a tagged data object from a data object of the set of data objects by matching a token of the data object to a tagged code from the set of defined codes. In some embodiments, the second classification machine learning model comprises a token-level classification model that is trained using a tagged training data object that comprises a set of training tokens and a set of ground truth tags respectively corresponding to the set of training tokens.

In some embodiments, generating the tagged data object from the data object comprises generating, by the second classification machine learning model, a set of code predictions that respectively correspond to the set of tokens. In some embodiments, generating the tagged data object from the data object comprises assigning the tagged code to the data object based on the set of code predictions.

In some embodiments, the process 600 comprises, at step/operation 610, providing an augmented authorization request. For example, the computing system 101 may, based at least in part on determining that the candidate code matches the tagged code, provide, by the one or more processors, an augmented authorization request to an entity repository. In some embodiments, the augmented authorization request comprises the authorization request and the tagged data object.

In some embodiments, the process 600 comprises, at step/operation 612, generating a second tagged data object. For example, the computing system 101 may generate, by the second classification machine learning model of the composite model framework, a second tagged data object from a second data object of the set of data objects by matching a second token of the data object to a second tagged code from the set of defined codes.

In some embodiments, the process 600 comprises, at step/operation 614, removing the second data object from the temporary memory storage. For example, the computing system 101 may, based at least in part on a determining that the candidate code does not match the second tagged code, remove the second data object from the temporary memory structure.

In some embodiments, the process 600 comprises, at step/operation 616, generating a second candidate code. For example, the computing system 101 may generate, by the first classification machine learning model, a second candidate code for the authorization request. In some embodiments, the process 600 comprises, at step/operation 618, providing an intermediate authorization response. For example, the computing system 101 may, based at least in part on determining that the second candidate code does not match the tagged code, provide, to the user device, an intermediate authorization response that identifies the second candidate code.

Some techniques of the present disclosure enable the generation of action outputs that may be performed to initiate one or more real world actions to achieve real-world effects. The techniques of the present disclosure may be used, applied, and/or otherwise leveraged to cause augmented authorization requests and/or the like to be rendered on a graphical user interface and/or be implemented in downstream models. In some examples, the augmented authorization requests of the present disclosure may trigger action outputs (e.g., through control instructions) to automate entity operations and/or the like. The action outputs may control various aspects of a client device, such as the display, transmission, and/or the like of data reflective of an alert, and/or the like. The alert may be automatically communicated to a user and/or may be used to initiate a security protocol (e.g., locking a computer), a robotic action (e.g., performing an automated screening process), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as comprising logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model’s architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model’s architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model comprising one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model’s parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.

Example 1. A computer-implemented method comprising receiving, by one or more processors, an authorization request for an entity; generating, by a first classification machine learning model of a composite model framework and based at least in part on the authorization request, a candidate code from among a set of defined codes; storing, by the one or more processors and within a temporary memory structure, a set of data objects associated with the authorization request; generating, by a second classification machine learning model of the composite model framework and based at least in part on a data object of the set of data objects, a tagged data object by associating a token of the data object with a tagged code from the set of defined codes; and based at least in part on determining that the candidate code matches the tagged code, providing, by the one or more processors, an augmented authorization request to an entity repository, wherein the augmented authorization request comprises the authorization request and the tagged data object; or based at least in part on determining that the candidate code does not match the tagged code, removing, by the one or more processors, the data object from the temporary memory structure.

Example 2. The computer-implemented method of example 1, wherein the authorization request is received from a user device, and the computer-implemented method further comprises generating, by the first classification machine learning model and based at least in part on the authorization request, a second candidate code; and based at least in part on determining that the candidate code does not match the tagged code, providing, to the user device, an intermediate authorization response that identifies the second candidate code.

Example 3. The computer-implemented method of any of the preceding examples, wherein the first classification machine learning model comprises a multi-label classification model that is configured to generate a set of classification predictions that respectively correspond to the set of defined codes and the candidate code corresponds to a classification prediction of the set of classification predictions that meets or exceeds a classification threshold.

Example 4. The computer-implemented method of example 3, wherein the multi-label classification model is trained using a multi-label training data entry that comprises a historical authorization request and a ground truth code set, wherein the ground truth code set is automatically generated by applying a reference data object corresponding to the historical authorization request to the second classification machine learning model.

Example 5. The computer-implemented method of any of the preceding examples, wherein the second classification machine learning model comprises a token-level classification model that is trained using a tagged training data object that comprises a set of training tokens and a set of ground truth tags respectively corresponding to the set of training tokens.

Example 6. The computer-implemented method of any of the preceding examples, further comprising determining a set of tokens based at least in part on the data object and generating the tagged data object from the data object further comprises generating, by the second classification machine learning model, a set of code predictions that respectively correspond to the set of tokens; and assigning the tagged code to the data object based on the set of code predictions.

Example 7. The computer-implemented method of any of the preceding examples, wherein storing, within the temporary memory structure, the set of data objects associated with the authorization request comprises extracting, by a filtering service of the composite model framework, a filtering label from the authorization request; and retrieving, by the filtering service of the composite model framework, the set of data objects, wherein the data object is retrieved from a first data object repository of a set of data object repositories and a second data object is retrieved from a second data object repository of the set of data object repositories.

Example 8. The computer-implemented method of example 7, herein retrieving the set of data objects comprises extracting, by the filtering service of the composite model framework, he tokens from a tabular structure; and responsive to extracting the token, generating the data object.

Example 9. A system comprising one or more processors and one or more memories storing processor-executable instructions that, when executed by the one or more processors, cause the one or more processors to perform operations comprising receiving an authorization request for an entity; generating, by a first classification machine learning model of a composite model framework and based at least in part on the authorization request, a candidate code from among a set of defined codes; storing, within a temporary memory structure, a set of data objects associated with the authorization request; generating, by a second classification machine learning model of the composite model framework and based at least in part on a data object of the set of data objects, a tagged data object by associating a token of the data object with a tagged code from the set of defined codes; and based at least in part on determining that the candidate code matches the tagged code, providing an augmented authorization request to an entity repository, wherein the augmented authorization request comprises the authorization request and the tagged data object.

Example 10. The system of example 9, wherein the operations further comprise generating, by the second classification machine learning model of the composite model framework and based at least in part on a second data object of the set of data objects, a second tagged data object by associating a second token of the data object with a second tagged code from the set of defined codes; and based at least in part on determining that the candidate code does not match the second tagged code, removing the second data object from the temporary memory structure.

Example 11. The system of any of examples 9 or 10, wherein the authorization request is received from a user device, and wherein the operations further comprise generating, by the first classification machine learning model and based at least in part on the authorization request, a second candidate code ; and based at least in part on determining that the second candidate code does not match the tagged code, providing, to the user device, an intermediate authorization response that identifies the second candidate code.

Example 12. The system of examples 9 through 11, wherein the first classification machine learning model comprises a multi-label classification model that is configured to generate a set of classification predictions that respectively correspond to the set of defined codes and the candidate code corresponds to a classification prediction of the set of classification predictions that meets or exceeds a classification threshold.

Example 13. The system of example 12, wherein the multi-label classification model is trained using a multi-label training data entry that comprises a historical authorization request and a ground truth code set, wherein the ground truth code set is automatically generated by applying a reference data object corresponding to the historical authorization request to the second classification machine learning model.

Example 14. The system of examples 9 through 13, wherein the second classification machine learning model comprises a token-level classification model that is trained using a tagged training data object that comprises a set of training tokens and a set of ground truth tags respectively corresponding to the set of training tokens.

Example 15. The system of examples 9 through 14, wherein the operations further comprise determining a set of tokens based at least in part on the data object and generating the tagged data object from the data object further comprises generating, by the second classification machine learning model, a set of code predictions that respectively correspond to the set of tokens; and assigning the tagged code to the data object based on the set of code predictions.

Example 16. The system of examples 9 through 15, wherein storing, within the temporary memory structure, the set of data objects associated with the authorization request comprises extracting, by a filtering service of the composite model framework, a filtering label from the authorization request; and retrieving, by the filtering service of the composite model framework, the set of data objects, wherein the data object is retrieved from a first data object repository of a set of data object repositories and a second data object is retrieved from a second data object repository of the set of data object repositories.

Example 17. The system of example 16, wherein retrieving the set of data objects comprises extracting, by the filtering service of the composite model framework, the token from a tabular structure; and responsive to extracting the token, generating the data object.

Example 18. One or more non-transitory computer-readable media storing processor-executable instructions that, when executed by one or more processors, cause the one or more processors to perform operations comprising receiving an authorization request for an entity; generating, by a first classification machine learning model of a composite model framework and based at least in part on the authorization request, a candidate code from among a set of defined codes; storing, within a temporary memory structure, a set of data objects associated with the authorization request; generating, by a second classification machine learning model of the composite model framework and based at least in part on a data object of the set of data objects, a tagged data object by associating a token of the data object with a tagged code from the set of defined codes; and based at least in part on determining that the candidate code matches the tagged code, providing an augmented authorization request to an entity repository, wherein the augmented authorization request comprises the authorization request and the tagged data object.

Example 19. The one or more non-transitory computer-readable storage media of example 18, wherein the operations further comprise generating, by the second classification machine learning model of the composite model framework and based at least in part on a second data object of the set of data objects, a second tagged data object by associating a second token of the data object with a second tagged code from the set of defined codes; and based at least in part on determining that the candidate code does not match the second tagged code, removing the second data object from the temporary memory structure.

Example 20. The one or more non-transitory computer-readable storage media of examples 18 or 19, wherein the authorization request is received from a user device and wherein the operations further comprise: generating, by the first classification machine learning model and based at least in part on the authorization request, a second candidate code; and based at least in part on determining that the second candidate code does not match the tagged code, providing, to the user device, an intermediate authorization response that identifies the second candidate code.

Example 21. The computer-implemented method of example 1, wherein the method further comprises training the first classification machine learning model and/or the second classification machine learning model.

Example 22. The computer-implemented method of example 21, wherein the training is performed by the one or more processors.

Example 23. The computer-implemented method of example 21, wherein the one or more processors are comprised in a first computing entity; and the training is performed by one or more other processors comprised in a second computing entity.

Example 24. The computing system of example 9, wherein the one or more processors are further configured to train the first classification machine learning model and/or the second classification machine learning model.

Example 25. The computing system of example 24, wherein the one or more processors are comprised in a first computing entity; and the first classification machine learning model and/or the second classification machine learning model are trained by one or more other processors comprised in a second computing entity.

Example 26. The one or more non-transitory computer-readable storage media of example 18, wherein the instructions further cause the one or more processors to train the first classification machine learning model and/or the second classification machine learning model.

Example 27. The one or more non-transitory computer-readable storage media of example 26, wherein the one or more processors are comprised in a first computing entity; and the first classification machine learning model and/or the second classification machine learning model are trained by one or more other processors comprised in a second computing entity.

What is claimed is:

1. A computer-implemented method comprising:
receiving, by one or more processors, an authorization request for an entity;
generating, by a first classification machine learning model of a composite model framework and based at least in part on the authorization request, a candidate code from among a set of defined codes;
storing, by the one or more processors and within a temporary memory structure, a set of data objects associated with the authorization request;
generating, by a second classification machine learning model of the composite model framework and based at least in part on a data object of the set of data objects, a tagged data object by associating a token of the data object with a tagged code from the set of defined codes; and
based at least in part on determining that the candidate code matches the tagged code, providing, by the one or more processors, an augmented authorization request to an entity repository, wherein the augmented authorization request comprises the authorization request and the tagged data object; or
based at least in part on determining that the candidate code does not match the tagged code, removing, by the one or more processors, the data object from the temporary memory structure.

2. The computer-implemented method of claim 1, wherein the authorization request is received from a user device, and the computer-implemented method further comprises:
generating, by the first classification machine learning model and based at least in part on the authorization request, a second candidate code; and
based at least in part on determining that the candidate code does not match the tagged code, providing, to the user device, an intermediate authorization response that identifies the second candidate code.

3. The computer-implemented method of claim 1, wherein the first classification machine learning model comprises a multi-label classification model that is configured to generate a set of classification predictions that respectively correspond to the set of defined codes and the candidate code corresponds to a classification prediction of the set of classification predictions that meets or exceeds a classification threshold.

4. The computer-implemented method of claim 3, wherein the multi-label classification model is trained using a multi-label training data entry that comprises a historical authorization request and a ground truth code set, wherein the ground truth code set is automatically generated by applying a reference data object corresponding to the historical authorization request to the second classification machine learning model.

5. The computer-implemented method of claim 1, wherein the second classification machine learning model comprises a token-level classification model that is trained using a tagged training data object that comprises a set of training tokens and a set of ground truth tags respectively corresponding to the set of training tokens.

6. The computer-implemented method of claim 1, further comprising determining a set of tokens based at least in part on the data object and generating the tagged data object from the data object further comprises:
generating, by the second classification machine learning model, a set of code predictions that respectively correspond to the set of tokens; and
assigning the tagged code to the data object based on the set of code predictions.

7. The computer-implemented method of claim 1, wherein storing, within the temporary memory structure, the set of data objects associated with the authorization request comprises:
extracting, by a filtering service of the composite model framework, a filtering label from the authorization request; and
retrieving, by the filtering service of the composite model framework, the set of data objects, wherein the data object is retrieved from a first data object repository of a set of data object repositories and a second data object is retrieved from a second data object repository of the set of data object repositories.

8. The computer-implemented method of claim 7, wherein retrieving the set of data objects comprises:
extracting, by the filtering service of the composite model framework, the token from a tabular structure; and
responsive to extracting the token, generating the data object.

9. A system comprising:
one or more processors; and
one or more memories storing processor-executable instructions that, when executed by the one or more processors, cause the one or more processors to perform operations comprising:
receiving an authorization request for an entity;
generating, by a first classification machine learning model of a composite model framework and based at least in part on the authorization request, a candidate code from among a set of defined codes;
storing, within a temporary memory structure, a set of data objects associated with the authorization request;
generating, by a second classification machine learning model of the composite model framework and based at least in part on a data object of the set of data objects, a tagged data object by associating a token of the data object with a tagged code from the set of defined codes; and
based at least in part on determining that the candidate code matches the tagged code, providing an augmented authorization request to an entity repository, wherein the augmented authorization request comprises the authorization request and the tagged data object.

10. The system of claim 9, wherein the operations further comprise:
generating, by the second classification machine learning model of the composite model framework and based at least in part on a second data object of the set of data objects, a second tagged data object by associating a second token of the data object with a second tagged code from the set of defined codes; and
based at least in part on determining that the candidate code does not match the second tagged code, removing the second data object from the temporary memory structure.

11. The system of claim 9, wherein the authorization request is received from a user device, and wherein the operations further comprise:
generating, by the first classification machine learning model and based at least in part on the authorization request, a second candidate code ; and
based at least in part on determining that the second candidate code does not match the tagged code, providing, to the user device, an intermediate authorization response that identifies the second candidate code.

12. The system of claim 9, wherein the first classification machine learning model comprises a multi-label classification model that is configured to generate a set of classification predictions that respectively correspond to the set of defined codes and the candidate code corresponds to a classification prediction of the set of classification predictions that meets or exceeds a classification threshold.

13. The system of claim 12, wherein the multi-label classification model is trained using a multi-label training data entry that comprises a historical authorization request and a ground truth code set, wherein the ground truth code set is automatically generated by applying a reference data object corresponding to the historical authorization request to the second classification machine learning model.

14. The system of claim 9, wherein the second classification machine learning model comprises a token-level classification model that is trained using a tagged training data object that comprises a set of training tokens and a set of ground truth tags respectively corresponding to the set of training tokens.

15. The system of claim 9, wherein the operations further comprise determining a set of tokens based at least in part on the data object and generating the tagged data object from the data object further comprises:
generating, by the second classification machine learning model, a set of code predictions that respectively correspond to the set of tokens; and
assigning the tagged code to the data object based on the set of code predictions.

16. The system of claim 9, wherein storing, within the temporary memory structure, the set of data objects associated with the authorization request comprises:
extracting, by a filtering service of the composite model framework, a filtering label from the authorization request; and
retrieving, by the filtering service of the composite model framework, the set of data objects, wherein the data object is retrieved from a first data object repository of a set of data object repositories and a second data object is retrieved from a second data object repository of the set of data object repositories.

17. The system of claim 16, wherein retrieving the set of data objects comprises:
extracting, by the filtering service of the composite model framework, the token from a tabular structure; and
responsive to extracting the token, generating the data object.

18. One or more non-transitory computer-readable media storing processor-executable instructions that, when executed by one or more processors, cause the one or more processors to perform operations comprising:
receiving an authorization request for an entity;
generating, by a first classification machine learning model of a composite model framework and based at least in part on the authorization request, a candidate code from among a set of defined codes;
storing, within a temporary memory structure, a set of data objects associated with the authorization request;
generating, by a second classification machine learning model of the composite model framework and based at least in part on a data object of the set of data objects, a tagged data object by associating a token of the data object with a tagged code from the set of defined codes; and
based at least in part on determining that the candidate code matches the tagged code, providing an augmented authorization request to an entity repository, wherein the augmented authorization request comprises the authorization request and the tagged data object.

19. The one or more non-transitory computer-readable storage media of claim 18, wherein the operations further comprise:
generating, by the second classification machine learning model of the composite model framework and based at least in part on a second data object of the set of data objects, a second tagged data object by associating a second token of the data object with a second tagged code from the set of defined codes; and
based at least in part on determining that the candidate code does not match the second tagged code, removing the second data object from the temporary memory structure.

20. The one or more non-transitory computer-readable storage media of claim 18, wherein the authorization request is received from a user device and wherein the operations further comprise:
generating, by the first classification machine learning model and based at least in part on the authorization request, a second candidate code ; and
based at least in part on determining that the second candidate code does not match the tagged code, providing, to the user device, an intermediate authorization response that identifies the second candidate code.
